(19) United States
(12) Patent Application Publication
(10) Pub. No.: US 2021/0079162 A1
(43) Pub. Date: Mar. 18, 2021

(54) POLYIMIDE PRECURSOR SOLUTION AND METHOD FOR PRODUCING POLYIMIDE FILM

(71) Applicant: FUJI XEROX CO., LTD., Tokyo (JP)

(72) Inventors: Yasunobu KASHIMA, Kanagawa (JP); Kosaku YOSHIMURA, Kanagawa (JP); Kosuke NAKADA, Kanagawa (JP); Hidekazu HIROSE, Kanagawa (JP)

(73) Assignee: FUJI XEROX CO., LTD., Tokyo (JP)

(21) Appl. No.: 16/744,139

(22) Filed: Jan. 15, 2020

(30) Foreign Application Priority Data
Sep. 18, 2019 (JP) 2019-169127

(51) Int. Cl. C08G 73/12; B05D 3/02; C08G 73/10; C09D 179/08

(52) U.S. Cl. CPC C08G 73/128; C09D 179/085; C08G 73/1032; B05D 3/0254

(57) ABSTRACT

A polyimide precursor solution includes a polyimide precursor having a weight average molecular weight within a range of 20000 to 80000, particles, and an aqueous solvent. The aqueous solvent contains an organic amine compound (A) (excluding a water-soluble organic solvent (B) described below), a water-soluble organic solvent (B) containing at least one selected from the group consisting of N-methyl-2-pyrrolidone, 1,3-dimethyl-2-imidazolidinone, N,N-dimethylformamide, and N,N-dimethylacetamide, and water (C). A content ratio [(A):(B):(C)] of (A), (B), and (C) is within a range of 0.02 to 0.07:0.02 to 0.05:0.88 to 0.96 in terms of mass ratio.

### CROSS-REFERENCE TO RELATED APPLICATIONS

This application is based on and claims priority under 35 USC 119 from Japanese Patent Application No. 2019-169127 filed Sep. 18, 2019.

### BACKGROUND

### (i) Technical Field

The present disclosure relates to a polyimide precursor solution and a method for producing a polyimide film.

### (ii) Related Art

Polyimide resins are materials having excellent characteristics such as mechanical strength, chemical stability, and heat resistance, and polyimide films having these characteristics attract attention.

Polyimide films may be applied to uses for filters (a filtration filter, an oil filter, a fuel filter, and the like), uses for secondary batteries (a separator for a lithium ion secondary battery, a holding body for a solid electrolyte of an all-solid-state battery, and the like) etc.

For example, Japanese Unexamined Patent Application Publication No. 2016-17145 describes a polyimide precursor composition prepared by dissolving, in a mixed solvent containing water and N-methyl-2-pyrrolidone at a water ratio of 10 to 90% by mass, polyamic acid having a specific repeating unit and a basic compound selected from the group consisting of imidazoles and amine compounds.

Also, Japanese Unexamined Patent Application Publication No. 2016-30760 discloses a polyimide precursor composition prepared by dissolving, in an aqueous solvent containing at least one selected from the group consisting of water and water-soluble alcohols, a tertiary amine compound and a polyimide precursor composed of a polycondensate of tetracarboxylic dianhydrides, containing a first tetracarboxylic dianhydride having a benzene ring to which two carboxylic anhydride groups are bonded, and a second tetracarboxylic dianhydride other than the first tetracarboxylic dianhydride, with a diamine compound.

### SUMMARY

In a precursor solution containing a polyimide precursor, particles, and an aqueous solvent, the polyimide precursor (polyamic acid) having a high molecular weight may make nonuniform the thickness of the resultant polyimide film.

Aspects of non-limiting embodiments of the present disclosure relate to a polyimide precursor solution containing a polyimide precursor, having a weight average molecular weight of 20,000 or more and 80,000 or less, particles, and an aqueous solvent containing an organic amine compound (A) (excluding a water-soluble organic solvent (B) described below), the water-soluble organic solvent (B) containing at least one selected from the group consisting of N-methyl pyrrolidone, iimdazolidinone, dimethylformamide, and dimethylacetamide, and water (C). The polyimide precursor solution can produce a polyimide film with suppressed thickness unevenness as compared with the case not satisfying a content ratio [(A):(B):(C)] of 0.02 or more and 0.07 or less:0.02 or more and 0.05 or less:0.88 or more and 0.96 or less in terms of mass ratio.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a polyimide precursor solution including a polyimide precursor with a weight average molecular weight of 20,000 or more and 80,000 or less, particles, and an aqueous solvent containing an organic amine compound (A) (excluding a water-soluble organic solvent (B) described below), the water-soluble organic solvent (B) containing at least one selected from the group consisting of N-methyl pyrrolidone, 1,3-dimethyl-2-iimdazolidinone, N,N-dimethylformamide, and N,N-dimethylacetamide, and water (C). A content ratio [(A):(B):(C)] is 0.02 or more and 0.07 or less:0.02 or more and 0.05 or less:0.88 or more and 0.96 or less in terms of mass ratio.

### BRIEF DESCRIPTION OF THE DRAWINGS

Exemplary embodiments of the present disclosure will be described in detail based on the following figures, wherein:

FIG. 1 is a schematic drawing showing a porous polyimide film as an example of the form of a polyimide film according to an exemplary embodiment of the present disclosure;

FIG. 2 is a schematic partial sectional view showing an example of a lithium ion secondary battery to which a separator for a lithium ion secondary battery is applied, the separator being produced by a method for producing a separator for a lithium ion secondary battery according to an exemplary embodiment of the present disclosure; and

FIG. 3 is a schematic partial sectional view showing an example of an all-sloid-state battery to which a polyimide film according to an exemplary embodiment of the present disclosure is applied.

### DETAILED DESCRIPTION

Exemplary embodiments of the present disclosure are described in detail below.

In the exemplary embodiments of the present disclosure, the concept of “film” includes not only those generally called “film” but also those generally called “film” and “sheet”.

<Polyimide Precursor Solution>

A polyimide precursor solution according to an exemplary embodiment of the present disclosure includes a polyimide precursor with a weight average molecular weight of 20,000 or more and 80,000 or less, particles, and an aqueous solvent containing an organic amine compound (A) (excluding a water-soluble organic solvent (B) below), the water-soluble organic solvent (B) containing at least one selected from the group consisting of N-methyl pyrrolidone, 1,3-dimethyl-2-iimdazolidinone, dimethylformamide, and dimethylacetamide, and water (C). The content ratio [(A):(B):(C)] by mass is 0.02 or more and 0.07 or less:0.02 or more and 0.05 or less:0.88 or more and 0.96 or less.

The polyimide precursor solution according the exemplary embodiment of the present disclosure having the configuration described above can produce a polyimide film with suppressed thickness unevenness. The reason for this is unknown, but is supposed as follows.

In the polyimide precursor solution containing the polyimide precursor, the particles, and the aqueous solvent, the polyimide precursor (polyamic acid) having a high molecular weight has a long molecular chain, which easily causes the contained particles to be entangled with the long chain. Thus, it is considered that the mobility of the particles is decreased, and the viscosity of the polyimide precursor solution is increased. Therefore, the use of such a polyimide precursor solution generally tends to fail to obtain a polyimide film having a uniform thickness.

On the other hand, in the exemplary embodiment of the present disclosure, first, the polyimide precursor solution contains the water-soluble organic solvent (B), and thus the viscosity thereof is decreased. Further, the aqueous solvent contained in the polyimide precursor solution contains proper amounts of the organic amine compound (A) and the water-soluble organic solvent (B), and these are interposed between the long molecular chain of the polyimide precursor and the particles, thereby suppressing entanglement of the particles with the molecular chain. Therefore, aggregation of the particles is suppressed, and an increase in viscosity of the polyimide precursor solution is suppressed.

Therefore, it is considered that the polyimide precursor solution according to the exemplary embodiment of the present disclosure can produce a polyimide film with suppressed thickness unevenness in spite of containing the polyimide precursor having a weight average molecular weight of as high as 20,000 or more and 80,000 or less.

In addition, an increase in viscosity of the polyimide precursor solution is suppressed, resulting in a decrease in the occurrence of air bubble marks and cracks in the polyimide film.

### [Polyimide Precursor Solution]

### <Polyimide Precursor>

The polyimide precursor solution according to the exemplary embodiment of the present disclosure contains the polyimide precursor having a weight average molecular weight of 20,000 or more and 80,000 or less.

The polyimide precursor is a resin (polyimide precursor) having a repeating unit represented by general formula (I).

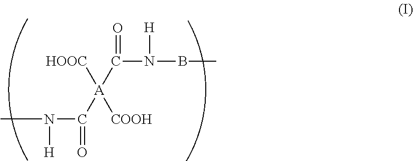

(In the general formula (I), A represents a tetravalent organic group, and B represents a divalent organic group.)

Herein, in the general formula (I), a tetravalent organic group represented by A is a residue formed by removing four carboxyl groups from a tetracarboxylic dianhydride used as a raw material.

On the other hand, a divalent organic group represented by B is a residue formed by removing two amino groups from a diamine compound used as a raw material.

That is, the polyimide precursor having the repeating unit represented by the general formula (I) is a polymer of the tetracarboxylic dianhydride and the diamine compound.

The tetracarboxylic dianhydride is, for example, an aromatic or aliphatic compound, but is preferably an aromatic compound. That is, the tetravalent organic group represented by A in the general formula (I) is preferably an aromatic organic group.

Examples of an aromatic tetracarboxylic dianhydride include pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenylether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furantetracarboxylic dianhydride, 4,4′-bis(3,4-dicarboxyphenoxy)diphenyl sulfide dianhydride, 4 4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, bis(triphenylphthalic acid)-4,4′-diphenylmethane dianhydride, and the like.

Examples of an aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetahydrofuryl)-3-methyl-3-cyclohexene-1,2-dicarboxylic dianhydride, bicyclo[2,2,2]-oct-7-ene-2,3,5,6-tetracarboxylic dianhydride, and the like; aliphatic tetracarboxylic dianhydrides each having an aromatic ring, such as 1,3,3a,4,5,9b-hexahydro-2,5-dioxo-3-furanyl)-naphtho [1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, 1,3,3a,4,5,9b-hexahydro-8-methyl-5-(tetrahydro-2,5-dioxo-3-furanyl)-naphtho[1,2-c]furan-1,3-dione, and the like; and the like.

Among these, the aromatic tetracarboxylic dianhydride is preferred as the tetracarboxylic dianhydride, and, specifically, for example, pyromellitic dianhydride, 3,3′,4,4′-biphenyltetracarboxylic dianhydride, 2,3,3′,4′-biphenyltetracarboxylic dianhydride, 3,3′,4,4′-biphenylether tetracarboxylic dianhydride, and 3,3′,4,4′-benzophenone tetracarboxylic dianhydride are preferred, pyromellitic dianhydride, 3,3′,4,4′-biphenyltetracarboxylic dianhydride, and 3,3′,4,4′-benzophenone tetracarboxylic dianhydride are more preferred, and 3,3′,4,4′-biphenyltetracarboxylic dianhydride is particularly preferred.

These tetracarboxylic dianhydrides may be used alone or in combination of two or more.

In the use of combination of two or more types, aromatic tetracarboxylic dianhydrides or aliphatic tetracarboxylic dianhydrides may be used in combination, or an aromatic tetracarboxylic dianhydride and an aliphatic tetracarboxylic dianhydride may be used in combination.

On the other hand, the diamine compound has two amino groups in its molecular structure. The diamine compound may be either an aromatic or aliphatic compound, but an aromatic compound is preferred. That is, in the general formula (I), the divalent organic group represented by B is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, -1,3′-bis(4-aminophenoxy)benzene, 9,9-bis(4-aminophenyl)fluorene, 4,4′-(p-phenyleneisopropylidene) bisaniline, 4,4′-(m-phenyleneisopropylidene)bisaniline, 2,2′-bis[4-(4-amino-2-trifluoromethylphenoxy)phenyl] hexafluoropropane, 4,4′-bis[4-(4-amino-2-trifluoromethyl)phenoxy]-octafluorobiphenyl, and the like; aromatic diamines such as diaminotetraphenylthiophene and the like, each having two amino groups bonded to an aromatic ring and a heteroatom other than the nitrogen atoms of the amino groups; aliphatic diamines and alicyclic diamines such as 1,1-meta-xylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylene diamine; hexahydro-4,7-metanoindanylene dimethylene diamine, tricyclo [6,2,1,0^{2.7}]-undecylene dimethyldiamine, 4,4′-methylene bis(cyclohexylamine), and the like; and the like.

Among these, the diamine compound is preferably an aromatic diamine compound, and specifically, for example, p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenyl sulfone are preferred, and 4,4′-diaminodiphenyl ether and p-phenylenediamine are particularly preferred.

These diamine compounds may be used alone or in combination of two or more. In the use of combination of two or more, aromatic diamine compounds or aliphatic diamine compounds may be used in combination, or an aromatic diamine compound and an aliphatic diamine compound may be used in combination.

The weight average molecular weight of the polyimide precursor used in the exemplary embodiment of the present disclosure is preferably 30,000 or more and 80,000 or less, more preferably 30,000 or more and 70,000 or less, and still more preferably 40,000 or more and 60,000 or less.

Although the polyimide precursor solution according to the exemplary embodiment of the present disclosure contains the polyimide precursor having a weight average molecular weight within the range described above, the polyimide film with suppressed thickness unevenness can be produced by using the polyimide precursor solution according to the exemplary embodiment of the present disclosure.

The weight average molecular weight of the polyimide precursor is measured by gel permeation chromatography (GPC) under measurement conditions described below.
Column: TOSOH TSK gel α-M (7.8 mm I.D×30 cm)
Eluent: DMF (dimethylformamide)/30 mM LiBr/60 mM phosphoric acid
Flow rate: 0.6 mL/min
Injection amount: 60 μL
Detector: RI (differential refractive index detector)

The content of the polyimide precursor contained in the polyimide precursor solution according to the exemplary embodiment of the present disclosure relative to the total mass of the polyimide precursor solution is 0.1% by mass or more and 10% by mass or less and preferably 0.5% by mass or more and 8% by mass or less.

### <Particles>

The polyimide precursor solution according to the exemplary embodiment of the present disclosure contains particles.

The particles are in the state of being dispersed, not dissolved, in the polyimide precursor solution according to the exemplary embodiment of the present disclosure, and the material of the particles is not particularly limited. In the exemplary embodiment of the present disclosure, the particles may remain contained in a polyimide film formed by using the polyimide precursor solution or may be removed from the polyimide film formed. The particles are roughly divided into resin particles and inorganic particles described below.

Herein, in the exemplary embodiment of the present disclosure, the expression “particles are not dissolved” includes, at 25° C., non-dissolution of particles in a liquid as an object and dissolution within a range of 3% by mass or less in a liquid as an object.

The volume average particle diameter D50v of the particles is not particularly limited. The volume average particle diameter D50v of the particles is preferably, for example, 0.1 μm or more and 10 μm or less. The volume average particle diameter of the particles may be 0.2 μm or more, 0.3 μm or more, 0.4 μm or more, or 0.5 μm or more. Also, the volume average particle diameter of the particles may be 7 μm or less, 5 μm or lee, 3 μm or less, or 2 μm or less. The volume particle size distribution index (GSDv) of the particles is preferably 1.30 or less, more preferably 1.25 or less, and most preferably 1.20 or less.

The volume particle size distribution index is calculated as (D84v/D16v)^{1/2} from the particle size distribution of the particles in a particle-dispersed polyimide precursor solution.

The particle size distribution of the particles in the polyimide precursor solution according to the exemplary embodiment is measured as follows. A solution to be measured is diluted, and the particle size distribution of particles in the solution is measured by using COULTER COUNTER LS13 (manufactured by Beckman Coulter, Inc.). Based on the measured particle size distribution, a volume-based cumulative distribution is drawn vs. divided particle size ranges (channels) from the small particle diameter side, measuring a particle size distribution.

In the volume-based cumulative distribution drown from the smaller particle diameter, the particle diameter at 16%, cumulation is regarded as the volume particle diameter D16v, the particle diameter at 50% cumulation is regarded as the volume-average particle diameter D50v, and the particle diameter at 84% cumulation is regarded as the volume particle diameter D84v.

When the method described above has difficulty in measuring the volume particle size distribution of the particles in the polyimide precursor solution of the exemplary embodiment of the present disclosure, the measurement is performed by a method such as a dynamic light scattering method or the like.

The shape of the particles is preferably spherical. When a porous polyimide film is formed by using spherical particles and then removing the particles from the polyimide film, a porous polyimide film having spherical pores can be formed.

In the exemplary embodiment of the present disclosure, the term “spherical” of the particles includes both a spherical shape and a substantially spherical shape (shape close to a spherical shape). Specifically, the term represents that particles having a ratio (long diameter/short diameter) of long diameter to short diameter of 1 or more and less 1.5 are present at a ratio of over 80%. The ratio of particles having a ratio (long diameter/short diameter) of long diameter to short diameter of 1 or more and less 1.5 is preferably 90% or more. The more the ratio of long diameter to short diameter is close to 1, the more the shape is close to a spherical shape.

Either resin particles or inorganic particles may be used as the particles, but the resin particles are preferably used.

The resin particles close to spherical particles are easily produced by a known production method such as emulsion polymerization as described below. Further, the resin particles and polyimide precursor are organic materials, and thus the particle dispersibility in a coating film and interfacial adhesion to the polyimide precursor are easily improved as compared with the use of inorganic particles. Also, in forming a porous polyimide film, the porous polyimide film having more nearly uniform pores and uniform pore diameters can be easily formed. For these reasons, the resin particles are preferably used.

The inorganic particles are, for example, silica particles. The silica particles close to spherical shape are preferred inorganic particles in view of availability. For example, the porous polyimide film having nearly spherical pores can be obtained by using the polyimide precursor solution using nearly spherical silica particles. However, when the silica particles are used as the particles, volume contraction is not easily absorbed during the imidization process, and thus fine cracks tend to easily occur in the polyimide film after imidization. Also, from this viewpoint, the resin particles are preferably used as the particles.

The particles are contained in the polyimide precursor solution according to the exemplary embodiment preferably at a volume ratio of 40% or more and 85% or less, more preferably at a volume ratio of 50% or more 80% or less, and still more preferably at a volume ratio of 50% or more and 70% or less relative to the total volume of the polyimide precursor solid content and the particles.

The method for measuring the volume ratio is as follows.

The volume ratio of the particles relative to the total volume of the polyimide precursor solid content and the particles represents the volume ratio of the particles in the polyimide film formed by using the polyimide precursor solution according to the exemplary embodiment of the present disclosure. The volume ratio of the particles in the polyimide film is determined by observing a section taken along the thickness direction of the polyimide film using a scanning electron microscope (SEM) according to the following method.

In a SEM image, any area S of the polyimide film is specified, and the total area A of the particles contained in the area S is determined. Assuming that the polyimide film is uniform, a value obtained by diving the total area A of the particles by the area S is converted to percent (o), determining the volume ratio of the particles in the polyimide film. The area S is an area sufficiently large relative to the particle size. For example, the area S is of such a size as to contain 100 or more particles. The area S may be a total of plural sections.

Specific materials of the resin particles and inorganic particles are described below.

### —Resin Particles—

Examples of the resin particles include resin particles of vinyl polymers such as polystyrenes, poly(meth)acrylic acids, polyvinyl acetate, polyvinyl alcohol, polyvinyl butyral, polyvinyl ether, and the like; condensed polymers such as polyester, polyurethane, polyamide, and the like; hydrocarbon polymers such as polyethylene, polypropylene, polybutadiene, and the like; fluorocarbon polymers such as polytetrafluoroethylene, polyvinyl fluoride, and the like; and the like.

Herein, the meaning of “(meth)acrylic” includes both “acrylic” and “methacrylic”. Also, “(meth)acrylic acids” includes “(meth)acrylic acid”, “(meth)acrylic acid esters”, and “(meth)acrylamide”.

In addition, the resin particles may be crosslinked or not be crosslinked. In the case of crosslinked resin particles, Bifunctional monomers such as divinylbenzene, ethylene glycol dimethacrylate, nonane diacrylate, decanediol diacrylate, and the like, and polyfunctional monomers such as trimethylolpropane triacrylate, trimethylolpropane trimethacrylate, and the like may be used in combination.

When the resin particles are vinyl resin particles, the resin particles are produced by polymerizing a monomer. The monomer of the vinyl resin is, for example, a monomer described below. Examples thereof include vinyl resin units produced by polymerizing monomers, such as styrene, alkyl-substituted styrene (for example, α-methylstyrene, 2-methylstyrene, 3-methylstyrene, 4-methylstyrene, 2-ethylstyrene, 3-ethylstyrene, 4-ethylstyrne, and the like), halogen-substituted styrene (for example, 2-chlorostyrene, 3-chlorostyrene, 4-chlorostyrene, and the like); styrenes each having a styrene skeleton, such as vinylnaphthalene and the like; (meth)acrylic acid esters such as methyl (meth)acrylate, ethyl (meth)acrylate, n-propyl (meth)acrylate, n-butyl (meth)acrylate, lauryl (meth)acrylate, 2-ethylhexyl (meth)acrylate, and the like; vinylnitriles such as acrylonitrile, methacrylonitrile, and the like; vinyl ethers such as vinyl methyl ether, vinyl isobutyl ether, and the like; vinyl ketones such as vinyl methyl ketone, vinyl ethyl ketone, vinyl isopropenyl ketone, and the like; acids such as (meth)acrylic acid, maleic acid, cinnamic acid, fumaric acid, vinylsulfonic acid, and the like; bases such as ethyleneimine, vinylpyridine, vinylamine, and the like; and the like.

A monofunctional monomer such as vinyl acetate or the like may be used in combination as another monomer.

Also, the vinyl resin may be a resin produced by using the monomers alone or a copolymer resin produced by using two or more monomers.

From the viewpoint of productivity and adaptability to a particle removing process described below, the resin particles are preferably resin particles of polystyrenes (also referred to as “styrene resin”), poly(meth)acrylic acids (also referred to as “(meth)acrylic resin”), or polyesters (also referred to as “polyester resin”). Specifically, the resin particles of polystyrene, styrene-(meth)acrylic acid copolymer, or poly(meth)acrylic acids are more preferred, and the resin particles of polystyrene or poly(meth)acrylic acid esters are most preferred. These types of resin particles may be used alone or in combination of two or more.

The “styrene resin” contains a styrene monomer (monomer having a styrene skeleton) as a constituent unit, and when the total composition of a polymer is 100 mol %, the content of the constituent unit is preferably 30 mol % or more and more preferably 50 mol % or more.

In addition, the “(meth)acrylic resin” represents a methacrylic resin and an acrylic resin and contains a (meth)acrylic monomer (monomer having a (meth)acryloyl skeleton) as a constituent unit. For example, when the total composition of a polymer is 100 mol %, the total ratio of the constituent unit derived from (meth)acrylic acid and the constituent unit derived from (meth)acrylic acid ester is preferably 30 mol % or more and more preferably 50 mol % or more.

Also, the “polyester resin” is a polymer compound having an ester bond in its molecular chain.

The resin particles preferably maintain the shape thereof during the preparation of the polyimide precursor solution according to the exemplary embodiment of the present disclosure and during the application of the polyimide precursor solution and drying of the coating film (before the removal of the resin particles) for forming the polyimide film. From this viewpoint, the glass transition temperature of the resin particles is 60° C. or more, preferably 70° C. or more, and still more preferably 80° C. or more.

The glass transition temperature is determined from a DSC curve obtained by differential scanning calorimetry (DSC), and specifically determined by “Extrapolated glass transition onset temperature” described in the method for determining a glass transition temperature in JIS K 7121-1987 “Testing Methods for Transition Temperatures of Plastics”.

### —Inorganic Particles—

Examples of the inorganic particles include inorganic particles such as silica (silicon dioxide) particles, magnesium oxide particles, alumina particles, zirconia particles, calcium carbonate particles, calcium oxide particles, titanium dioxide particles, zinc oxide particles, cerium oxide particles, and the like. As described above, the shape of the particles is preferably a spherical shape. From this viewpoint, the inorganic particles are preferably silica particles, magnesium oxide particles, calcium carbonate particles, and alumina particles, more preferably silica particles, titanium oxide particles, and alumina particles, and still more preferably silica particles. These inorganic particle types may be used alone or in combination of two or more.

When the inorganic particles have insufficient wettability and dispersibility in the solvent of the polyimide precursor solution, the surfaces of the inorganic particles may be modified according to demand. Examples of a method of surface modification include a method of treating with alkoxysilane having an organic group, such as a silane coupling agent; a method of coating with an organic acid such as oxalic acid, citric acid, lactic acid, or the like; and the like.

The content of the particles contained in the polyimide precursor solution according to the exemplary embodiment of the present disclosure is 0.1% by mass or more and 40% by mass or less, preferably 0.5% by mass or more and 25% by mass or less, and more preferably 1% by mass or more and 20% by mass or less relative to the total mass of the polyimide precursor solution.

### <Aqueous Solvent>

The polyimide precursor solution according to the exemplary embodiment of the present disclosure contains an organic amine compound (A) (excluding a water-soluble organic solvent (B) described below), the water-soluble organic solvent (B) containing at least one selected from the group consisting of N-methyl-2-pyrrolidone, 1,3-dimethyl-2-imidazolidinone, N,N-dimethylformamide, and N,N-dimethylacetamide, and water (C), and the content ratio ((A):(B):(C)) of (A), (B), and (C) is 0.02 or more 0.07 or less:0.02 or more and 0.05 or less:0.88 or more and 0.96 or less in terms of mass ratio.

### —Organic Amine Compound (A)—

The aqueous solvent used in the exemplary embodiment of the present disclosure contains the organic amine compound (A) (also simply referred to as the “organic compound” or “(A)” hereinafter). However, the organic amine compound (A) excludes the water-soluble organic solvent (B) described below.

The organic amine compound is a compound which increases the solubility of the polyimide precursor in the aqueous solvent by forming an amine salt of the polyimide precursor (carboxyl group thereof) and which functions as an imidization promoter. Specifically, the organic amine compound is preferably a compound having a molecular weight of 170 or less. The organic amine compound is preferably a compound except for the diamine compound used as the raw material of the polyimide precursor.

The organic amine compound is preferably a water-soluble compound. The term “water-soluble” represents that 1% by mass or more of an object material is dissolved in water at 25° C.

The organic amine compound is, for example, a primary amine compound, a secondary amine compound, or a tertiary amine compound.

Among these, the organic amine compound is preferably at least one (particularly, the tertiary amine compound) selected from the secondary amine compound and the tertiary amine compound. When the tertiary amine compound or secondary amine compound (particularly, the tertiary amine compound) is applied as the organic amine compound, it is possible to easily increase the solubility of the polyimide precursor in the solvent, easily improve film formability, and easily improve the storage stability of the polyimide precursor solution.

Also, the organic amine compound is, for example, a divalent or higher polyvalent amine compound other than a monovalent amine compound. When a divalent or higher polyvalent amine compound is applied, a pseudo-crosslinked structure is easily formed between polyimide precursor molecules, and the storage stability of the polyimide precursor solution is easily improved.

Examples of the primary amine compound include methylamine, ethylamine, n-propylamine, isopropylamine, 2-ethanolamine, 2-amino-2-methyl-1-propanol, and the like.

Examples of the secondary amine compound include dimethylamine, 2-(methylamino)ethanol, 2-(ethylamino)ethanol, morpholine, and the like.

Examples of the tertiary amine compound include 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-alkylpiperidine (for example, N-methyl piperidine, N-ethyl piperidine, and the like), and the like.

From the viewpoint of obtaining the polyimide film with suppressed thickness unevenness, the tertiary amine compound is preferred. From this viewpoint, more preferred is at least one selected from the group consisting of 2-dimethylaminoethanol, 2-diethylaminoethaol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine. In particular, N-alkylmorpholine is preferably used.

From the viewpoint of obtaining the polyimide film with suppressed thickness unevenness, the organic amine compound is also preferably an amine compound with an aliphatic cyclic structure or an aromatic cyclic structure having a heterocyclic structure containing nitrogen (hereinafter, referred to as the “nitrogen-containing heterocyclic amine compound”). The nitrogen-containing heterocyclic amine compound is more preferably a tertiary amine compound. That is, a tertiary cyclic amine compound is more preferred.

Examples of the tertiary cyclic amine compound include isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyaniline, polypyridine, and the like.

From the viewpoint of obtaining the polyimide film with suppressed thickness unevenness, the tertiary cyclic amine compound is preferably at least one selected from the group consisting of morpholines, pyridines, piperidines, and imidazoles, and more preferably morpholines (amine compounds having a morpholine skeleton) (that is, morpholine compounds). Among these, more preferred is at least one selected from the group consisting of N-methylmorpholine, N-methylpiperidine, pyridine, 1,2-dimethylimidazole, 2-ethyl-4-methylimidazole, and picoline, and still more preferred is N-methylmorpholine.

These organic amine compounds may be used alone or in combination of two or more.

The content ratio of the organic amine compound (A) used in the exemplary embodiment of the present disclosure is preferably 1 mole % or more or 1.5 mol % or more relative to the total mass of the aqueous solvent contained in the polyimide precursor solution.

### —Water-Soluble Organic Solvent (B)—

The aqueous solvent used in the exemplary embodiment of the present disclosure contains the water-soluble organic solvent (B) (also simply referred to as the “water-soluble organic solvent” or “(B)” hereinafter). Herein, the “water-soluble” represents that 1% by mass or more of an object substance is dissolved in water at 25° C.

The water-soluble organic solvent includes an aprotic polar solvent.

Examples of the aprotic polar solvent include N-methyl-2-pyrrolidone (NMP), N,N-dimethylformamide (DMF), 1,3-dimethyl-2-imidazolidinone (DMI), N,N-dimethylacetamide (DMAc), N,N-diethylacetamide (DEAc), dimethyl sulfoxide (DMSO), hexamethylene phosphoramide (HMPA), N-methylcaprolactam, N-acetyl-2-pyrrolidone, 1,3-dimethyl-imidazolidone, and the like.

These water-soluble organic solvents may be used alone or in combination of two or more.

The content ratio of the water-soluble organic solvent (B) used in the exemplary embodiment of the present disclosure is preferably 1 mole % or more or 2 mol % or more relative to the total mass of the aqueous solvent contained in the polyimide precursor solution.

The water-soluble organic solvent has a boiling point of 270° C. or less, preferably 60° C. or more and 250° C. or less, and more preferably 80° C. or more and 230° C. or less. When the water-soluble organic solvent has a boiling point within the range, the water-soluble organic solvent hardly remains in the polyimide film, and the polyimide film having high mechanical strength can be easily produced.

### —Water (C)—

The aqueous solvent used in the exemplary embodiment of the present disclosure contains water (C) (also simply referred to as “water” or “(C)” hereinafter).

Examples of water include distilled water, ion-exchange water, ultrafiltered water, pure water, and the like.

The content ratio of water (C) used in the exemplary embodiment of the present disclosure is preferably 85% by mass or more, 88% by mass or more, and 91% by mass or more relative to the total mass of the aqueous solvent contained in the polyimide precursor solution.

The content ratio [(A):(B):(C)] of (A), (B), and (C) in the aqueous solvent used in the exemplary embodiment of the present disclosure is 0.02 or more and 0.07 or less:0.02 or more and 0.05 or less:0.88 or more and 0.96 or less in terms of mass ratio, and the polyimide film with suppressed thickness unevenness can be obtained by satisfying the content ratio. From the viewpoint of obtaining the polyimide film with suppressed thickness unevenness, the content ratio is preferably 0.02 or more and 0.03 or less: 0.03 or more and 0.05 or less: 0.92 or more and 0.96 or less.

The total content of (A), (B), and (C) in the aqueous solvent used in the exemplary embodiment of the present disclosure is preferably 100% by mass relative to the total mass of the aqueous solvent. When the total content is less than 100% by mass, another aqueous solvent may be mixed. The content of the other aqueous solvent relative to the total mass of the aqueous solvent is preferably 5% by mass or less, more preferably 3% by mass or less, still more preferably 1% by mass or less, and particularly preferably 0% by mass.

Examples of the other aqueous solvent include a water-soluble ether solvent, a water-soluble ketone solvent, a water-soluble alcohol solvent, and the like.

The water-soluble ether solvent is a water-soluble solvent having an ether bond in one molecule thereof. Examples of the water-soluble ether solvent include tetrahydrofuran (THF), dioxane, trioxane, 1,2-dimethoxyethane, diethylene glycol dimethyl ether, diethylene glycol diethyl ether, and the like. Among these, tetrahydrofuran and dioxane are preferred as the water-soluble ether solvent.

The water-soluble ketone solvent is a water-soluble solvent having a ketone group in one molecule. Examples of the water-soluble ketone solvent include acetone, methyl ethyl ketone, cyclohexanone, and the like. Among these, acetone is preferred as the water-soluble ketone solvent.

The water-soluble alcohol solvent is a water-soluble solvent having an alcoholic hydroxyl group in one molecule. Examples of the water-soluble alcohol solvent include methanol, ethanol, 1-propanol, 2-propanol, tert-butyl alcohol, ethylene glycol, ethylene glycol monoalkyl ethers, propylene glycol, propylene glycol monoalkyl ethers, diethylene glycol, diethylene glycol monoalkyl ethers, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, 1,2,6-hexanetriol and the like. Among these, methanol, ethanol, 2-propanol, ethylene glycol, ethylene glycol monoalkyl ethers, propylene glycol, propylene glycol monoalkyl ethers, diethylene glycol, and diethylene glycol monoalkyl ethers are preferred as the water-soluble alcohol solvent.

The content of the aqueous solvent contained in the polyimide precursor solution according to the exemplary embodiment of the present disclosure is 0.5% by mass or more and 10% by mass or less and preferably 1% by mass or more and 5% by mass or less relative to the total mass of the polyimide precursor solution.

### —Other Additives—

The polyimide precursor solution according to the exemplary embodiment of the present disclosure may contain a catalyst for promoting imidization reaction, and a leveling agent for improving film quality, etc.

Examples of the catalyst for promoting imidization reaction include acid catalysts such as a dehydrant such as an acid anhydride or the like, a phenol derivative, a sulfonic acid derivative, a benzoic acid derivative, and the like.

Also, the polyimide precursor solution may contain, for example, a conductive material (conductivity (for example, a volume resistivity of less than 10⁷ Ω·cm) or semiconductivity (for example, a volume resistivity of 10⁷ Ω·cm or more and 10¹³ Ω·cm or less)) added for imparting conductivity according to the purpose of use of the polyimide film.

Examples of the conductive material include carbon black (for example, acid carbon black at pH 5.0 or less); metals (for example, aluminum, nickel, and the like); metal oxides (for example, yttrium oxide, tin oxide, and the like); ion-conductive materials (for example, potassium titanate, LiCl, and the like); and the like. These conductive materials may be used alone or in combination of two or more.

Also, the polyimide precursor solution may contain the inorganic particles added for improving mechanical strength according to the purpose of use of the polyimide film. Examples of the inorganic particles include particle materials such as a silica powder, an alumina powder, a barium sulfate powder, a titanium oxide powder, mica, talc, and the like. Also, LiCoO₂, LiMn₂O, or the like, which is used as an electrode of a lithium ion battery, may be contained.

### (Characteristics of Polyimide Film)

### —Average Film Thickness—

The average thickness of the polyimide film formed by using the polyimide precursor solution according to the exemplary embodiment of the present disclosure is not particularly limited and is selected according to use. The average thickness may be, for example, 10 μm or more and 1000 μm or less. The average thickness may be 20 μm or more or 30 μm or more, and 500 μm or less or 400 μm or less.

The average thickness of the polyimide film according to the exemplary embodiment of the present disclosure is determined by measuring the thickness of the polyimide film at five points using eddy current thickness meter CTR-1500E manufactured by Sanko Electronic Laboratory Co., Ltd. and calculating an arithmetic average.

### [Method for Producing Polyimide Film]

A method for producing the polyimide film according to the exemplary embodiment of the present disclosure includes applying the polyimide precursor solution described above on a substrate to form a coating film, drying the coating film to form a film containing the polyimide precursor and the particles, and imidizing the polyimide precursor contained in the film to form the polyimide film.

Specifically, the polyimide contained in the polyimide film is produced by polymerizing a tetracarboxylic dianhydride with a diamine compound to produce a polyimide precursor and then performing imidization reaction of the resultant polyimide precursor solution. More specifically, the polyimide is produced by imidization reaction of the polyimide precursor solution according to the exemplary embodiment of the present disclosure. An example of the method includes polymerizing the tetracarboxylic dianhydride with the diamine compound in the presence of the organic amine compound in the aqueous solvent to produce a resin (polyimide precursor), preparing the polyimide precursor solution.

Although described is an example including polymerizing the tetracarboxylic dianhydride with the diamine compound in the presence of the organic amine compound to produce a resin (polyimide precursor), preparing the polyimide precursor solution, the method is not limited to this example.

### —Method for Preparing Polyimide Precursor Solution—

The method for preparing the polyimide precursor solution according to the exemplary embodiment of the present disclosure is not particularly limited, but an example of the method is as follows.

An example of the method for preparing the polyimide precursor solution includes polymerizing the tetracarboxylic dianhydride with the diamine compound in the presence of the organic amine compound in an aqueous solvent, thereby producing a resin (polyimide precursor).

This method uses the aqueous solvent and is thus advantageous in view of high productivity and simplification of the process due to the one-stage preparation of the polyimide precursor solution.

Another example of the method includes polymerizing, in an organic solvent such as an aprotic polar solvent (for example, N-methyl pyrrolidone (NMP) or the like), the tetracarboxylic dianhydride with the diamine compound to produce a resin (polyimide precursor), and then adding to an aqueous solvent such as water, alcohol, or the like, precipitating a resin (polyimide precursor). Then, the polyimide precursor and the organic amine compound are dissolved in the aqueous solvent to prepare the polyimide precursor solution.

An example of the preferred method for producing the polyimide film according to the exemplary embodiment of the present disclosure is described below.

The method for producing the polyimide film according to the exemplary embodiment of the present disclosure preferably includes a first process, a second process, and a third process described below.

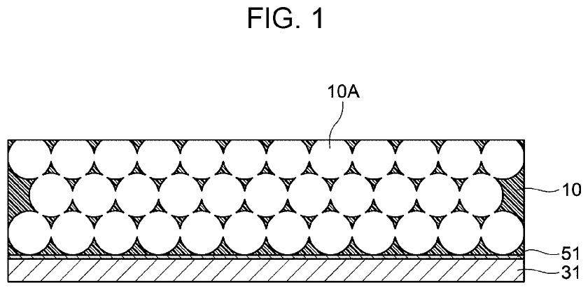

In the description of the production method, the same constituent parts shown in FIG. 1 referred to are denoted by the same reference numeral. In FIG. 1, reference numeral 31 denotes a substrate, reference numeral 51 denotes a release layer, reference numeral 10A denotes a pore, and reference numeral 10 denotes a porous polyimide film (an example of the “polyimide film”).

The first process includes applying the polyimide precursor solution according to the exemplary embodiment of the present disclosure on a substrate to form a coating film.

The second process includes drying the coating film to form a film containing the polyimide precursor and the particles.

The third process includes imidizing the polyimide precursor contained in the film to form the polyimide film.

The third process may further include a treatment of removing the resin particles by heating the film.

In addition, the treatment of removing the particles may be performed by removing the particles with an organic solvent which dissolves the particles or by removing by heating.

### (First Process)

In the first process, first, the polyimide precursor solution according to the exemplary embodiment of the present disclosure is prepared. Next, the polyimide precursor solution is applied on a substrate to form a coating film. The coating film contains a polyimide precursor-containing solution and the particles. The particles in the coating film are distributed in a state where aggregation is suppressed. Then, the coating film formed on the substrate is dried to form a film containing the polyimide precursor and the particles.

The substrate on which the film containing the polyimide precursor and the particles is formed is not particularly limited. Examples thereof include resin-made substrates of polystyrene, polyethylene terephthalate, and the like; glass substrates; ceramic substrates; metal substrates of iron, stainless steel (SUS), and the like; composite material substrates of combination of these materials; and the like. If required, a release layer may be provided on the substrate by, for example, release treatment with a silicone-based or fluorine-based release agent or the like. Also, it is effective to roughen the surface of the substrate to approximately the same size as the particle diameter of the particles and promote the exposure of the particles in the contact surface of the substrate.

A method for applying the polyimide precursor solution on the substrate is not particularly limited. Examples thereof include various methods such as a spray coating method, a spin coating method, a roll coating method, a bar coating method, a slit die coating method, an ink jet coating method, and the like.

When the polyimide precursor solution is applied on the substrate to form a coating film, the particles are added in such an amount that the particles are exposed from the surface of the coating film.

### (Second Process)

The second process includes drying the coating film formed in the first process to form the film containing the polyimide precursor and the particles.

After the resultant coating film containing the polyimide precursor solution and the particles is formed, the coating film is dried to form the film containing the polyimide precursor and the particles.

Specifically, the coating film containing the polyimide precursor and the particles is dried by, for example, a method of heat-drying, natural drying, vacuum drying, or the like to form the film. More specifically, the film is formed by drying the coating film so that the solvent remaining in the film is 50% or less, preferably 30% or less, relative to the solid content of the film. The film is in a state where the polyimide precursor can be dissolved in water.

Also, in the process of drying, after forming the coating film, the coating film to form the film, the particles may be exposed by the treatment of exposing the particles. The treatment of exposing the particles can increase the opening ratio of a porous polyimide film.

A specific example of the treatment of exposing the particles is the following method.

In the process of forming, after forming the coating film containing the polyimide precursor and the particles, a film containing the polyimide precursor and the particles by drying the coating film, as described above, the film is in a state where the polyimide precursor can be dissolved in water. In this state, the particles in the film can be exposed by, for example, the treatment of wiping, immersion in water, or the like. Specifically, the polyimide precursor-containing solution present above the particle layer is removed by the treatment of exposing the particle layer by wiping with water. Thus, the particles present in an upper region (that is, a region of the resin particle layer on the side apart from the substrate) are exposed from the surface of the film.

Even when the film containing the particles embedded therein is formed on the substrate by using the polyimide precursor solution, the same treatment as the treatment of exposing the particles described above can be used as the treatment of exposing the particles embedded in the film.

The method for preparing the polyimide precursor solution is not limited to the preparation method described above. From the viewpoint of simplifying the process, the polyimide precursor is also preferably synthesized in an aqueous solvent dispersion in which the particles not dissolved in the polyimide precursor-containing solution have been dispersed in an aqueous solvent. A specific example of the method is the following method.

The particles are formed in an aqueous solvent containing water to prepare a particle dispersion. Then, a resin (polyimide precursor) is produced by polymerizing the tetracarboxylic dianhydride with the diamine compound in the presence of the organic amine in the particle dispersion.

Further examples of the method for preparing the polyimide precursor solution include a method of mixing the polyimide precursor-containing solution with the particles in a dry state, a method of mixing the polyimide precursor-containing solution with a dispersion in which the particles have been dispersed in an aqueous solvent, and the like.

The dispersion in which the particles have been dispersed in an aqueous solvent may be a particle dispersion prepared by previously dispersing the particles in an aqueous solvent or may be a commercial product of a dispersion in which the particles are previously dispersed in an aqueous solvent.

Then, the polyimide precursor solution prepared as described above is applied on the substrate to form a coating film by the method described above. Then, the coating film is dried to form a film on the substrate.

### (Third Process)

In the third process, the polyimide precursor contained in the film formed in the second process is imidized to form the polyimide film. The third process may include treatment of removing the particles. A porous polyimide film (an example of the “polyimide film”) can be obtained through the treatment of removing the particles.

In the third process, in forming the polyimide film, specifically, imidization is allowed to proceed by heating the film formed in the second process and containing the polyimide precursor and the particles, and the polyimide film is formed by further heating. As imidization proceeds to increase the imidization ratio, dissolution in an organic solvent becomes difficult.

In the third process, the treatment of removing the particles may be performed. The particles may be removed in the process of imidizing the polyimide precursor by heating the film or removed from the polyimide film after (after imidization) the completion of imidization.

In the exemplary embodiment of the present disclosure, the process of imidizing the polyimide precursor is the process before the state where imidization is allowed to proceed by heating the film formed in the second process and containing the polyimide precursor and the particles, forming the polyimide film after the completion of imidization.

Specifically, the particles may be removed from the film (the film in this stage may be referred to as the “polyimide film” hereinafter) in the process of imidizing the polyimide precursor by heating the coating film which is formed in the first process and in which the particles are exposed. Alternatively, the particles may be removed from the polyimide film after the completion of imidization. Consequently, the porous polyimide film is produced, from which the particles have been removed (refer to FIG. 1).

For example, in the process of removing the particles, a component, for example, a resin component when the particles are resin particles, may be contained as a resin other than the polyimide resin in the porous polyimide film. Although not shown in the drawings, the porous polyimide film may contain a resin (for example, a resin component) other than the polyimide resin.

In view of particle removability or the like, the treatment of removing the particles is preferably performed when the imidization ratio of the polyimide precursor in the polyimide film is 10% or more during the process of imidizing the polyimide precursor. With the imidization ratio of 10% or more, a state insoluble in an organic solvent is easily created, and thus the form is easily maintained.

The treatment of removing the particles is not particularly limited. Examples thereof include a method of removing the particles by heating decomposition, a method of removing with an organic solvent which dissolves the particles, a method of removing by decomposition of the particles with a laser or the like, and the like.

The particles may be removed by, for example, only heating for both decomposition and imidization, or may be removed by combination of heating for decomposition and dissolution of the particles in an organic solvent. In view of more relaxing the residual stress and suppressing the occurrence of crack in the porous polyimide film, a preferred method includes the treatment of removing with an organic solvent which dissolves the particles. This function in the treatment of removing with the organic solvent is supposed to be due to the easy transfer of the component dissolved in the organic solvent into the polyimide resin.

For example, the method of removing by heating may cause a decomposed gas by heating depending on the type of the particles. Thus, breakage, cracking, or the like may occur in the porous polyimide film due to the decomposed gas. Therefore, in view of suppressing the occurrence of cracking, it is preferred to use the method of removing with an organic solvent which dissolves the particles.

In addition, it is also effective to increase the removal rate by further heating after the removal with the organic solvent which dissolves the particles.

Also, when the particles are removed by the method of removing with an organic solvent which dissolves the particles, the component of the particles dissolved in the organic solvent may enter the polyimide film during the process of removing the particles. In view of containing a resin other than the polyimide resin, it is more preferred to use the method of removing with an organic solvent which dissolves the particles. Further, in view of containing a resin other than the polyimide resin, this method of removing the particles is preferably performed for the film during imidization of the polyimide precursor. When in the state of the film during imidization, the particles are dissolved in a solvent which dissolves the particles, the component may more easily enter the polyimide film.

The method of removing with an organic solvent which dissolves the particles is, for example, a method of dissolving and removing the particles by contact (for example, immersion in the solvent or contact with solvent vapor) with the organic solvent which dissolves the particles. In this case, immersion in the solvent is desirable in view of increasing the dissolution efficiency of the particles.

The organic solvent which dissolves the resin particles and is used for removing the particles is not particularly limited as long as the organic solvent can dissolve the particles but does not dissolve the polyimide film and the polyimide film after the completion of imidization. When the particles are resin particles, examples of the organic solvent include ethers such as tetrahydrofuran, 1,4-dioxane, and the like; aromatics such as benzene, toluene, and the like; ketones such as acetone and the like; esters such as ethyl acetate and the like; and the like.

Among these, ethers such as tetrahydrofuran, 1,4-dioxane, and the like, and aromatics such as benzene, toluene, and the like are preferred, and tetrahydrofuran and toluene are more preferably used.

When the aqueous solvent remains at the time of dissolving the resin particles, the aqueous solvent is dissolved in the solvent which dissolves the uncrosslinked resin particles, and the polyimide precursor is precipitated, creating a state similar to a so-called wet phase transition method. This may cause difficulty in controlling the pore diameter, and thus the uncrosslinked resin particles are preferably removed by dissolution in the organic solvent after the amount of the aqueous solvent remaining is decreased to 20% by mass or less, preferably 10% by mass or less relative to the mass of the polyimide precursor.

In the third process, a heating method for allowing imidization to proceed by heating the film, formed in the second process, to form the polyimide film is not particularly limited. For example, a method of multi-stage heating in two or more stages can be used. For example, in the case of two-stage heating, specific heating conditions are as follows.

For example, when the particles are resin particles, a desired heating condition of the first stage is a temperature at which the shape of the resin particles can be maintained. Specifically, the temperature is, for example, within a range of 50° C. or more and 150° C. or less and preferably within a range of 60° C. or more and 140° C. or less. In addition, a heating time is preferably within a range of 10 minutes or more and 60 minutes or less. The higher the heating temperature, the shorter the heating time.

Heating conditions of the second stage are, for example, heating conditions of 150° C. or more and 450° C. or less (preferably 200° C. or more and 400° C. or less) and 20 minutes or more and 120 minutes or less. Under these heating conditions within the respective ranges, imidization reaction further proceeds, and the polyimide film can be formed. In the heating reaction, heating may be performed by increasing the temperature stepwisely or gradually at a constant rate before the temperature reaches the final heating temperature.

The heating conditions are not limited to the conditions of the two-stage heating method, and a method of heating in one stage may be used. In the case of the one-stage heating method, for example, imidization may be completed under only the heating conditions of the second stage described above.

When the treatment of exposing the resin particles is not performed in the first process, in view of increasing an opening ratio, the resin particles may be exposed by treatment of exposing the resin particles in the third process. The treatment of exposing the resin particles in the third process is preferably performed during the process of imidizing the polyimide precursor or after imidization and before the treatment of removing the resin particles.

The treatment of exposing the resin particles is performed, for example, when the polyimide film has the following state.

In the case of treatment of exposing the resin particles when the imidization ratio of the polyimide precursor in the polyimide film is less than 10% (that is, in the state where the polyimide film can be dissolved in water), examples of the treatment of exposing the resin particles embedded in the polyimide film include a treatment of wiping, a treatment of immersion in water, and the like.

In the treatment of exposing the resin particles when the imidization ratio of the polyimide precursor in the polyimide film is 10% or more (that is, in a state insoluble in the organic solvent) and when the polyimide film is formed after the completion of imidization, examples of a usable method include a method of exposing the resin particles by mechanically cutting with a tool such as sandpaper, a method of etching with an alkali solution which dissolves the polyimide resin, and a method of exposing the resin particles by decomposition with a laser or the like.

For example, in the case of mechanical cutting, the resin particles present in an upper region (that is, a region of the resin particle layer on the side apart from the substrate) of the resin particle layer embedded in the polyimide film are partially cut together with the polyimide film present in the upper portions of the resin particles, and the cut resin particles are exposed from the surface of the polyimide film.

Then, the resin particles are removed, by the resin particle removing treatment described above, from the polyimide film in which the resin particles are exposed. Thus, the porous polyimide film, from which the resin particles have been removed, can be formed.

In this case, when the film is formed on the substrate by using the polyimide precursor solution, the polyimide precursor solution is applied on the substrate to form a coating film in which the particles are embedded. When a film containing the polyimide precursor and the particles is formed by drying the coating film without the treatment of exposing the particles, the film in which the particles are embedded may be formed. For example, in the case where the particles are resin particles, when the film in which the resin particles are embedded is heated, the film is put into a state where a resin particle layer is embedded during the imidization process. The treatment of exposing the resin particles in order to increase the opening ratio in the third process may be the same treatment as for exposing the resin particles described above. Thus, the resin particles are cut together with the polyimide film present above the resin particles, and the resin particles are exposed from the surface of the polyimide film.

Then, the resin particles are removed, by the resin particle removing treatment described above, from the polyimide film in which the resin particles have been exposed. Thus, the porous polyimide film, from which the resin particles have been removed, can be formed.

The substrate used for forming the film may be separated when the dry film is formed in the second process, or in the third process, the substrate may be separated when the polyimide precursor in the polyimide film is in a state insoluble in the organic solvent or may be separated when the film is formed after the completion of imidization.

The imidization ratio of the polyimide precursor is described herein.

Examples of a partially imidized polyimide precursor include precursors having structures each having a repeating unit represented by any one of a general formula (I-1), general formula (I-2), and general formula (I-3) below.

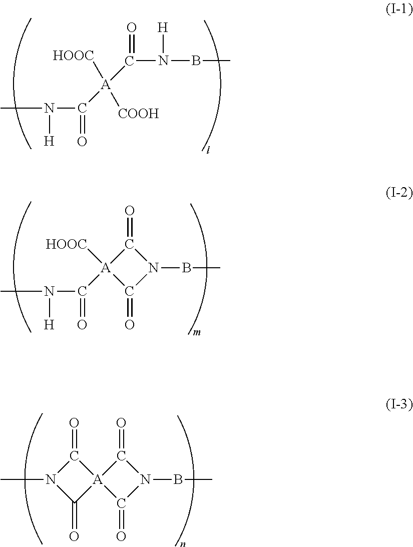

In the general formula (I-1), the general formula (I-2), and the general formula (I-3), A represents a tetravalent organic group, B represents a divalent organic group, 1 represents an integer of 1 or more, and m and n each independently represent 0 or an integer of 1 or more.

In addition, A and B represent the same meanings as A and B, respectively, in the general formula (I) described above.

The imidization ratio of the polyimide precursor represents the ratio of the number (2n+m) of imide ring-closed bond parts to the total number of bond parts (2l+2m+2n) in bond parts (reaction parts between tetracarboxylic dianhydride and diamine compound) of the polyimide precursor. That is, the imidization ratio of the polyimide precursor is represented by “(2n+m)/(2l+2m+2n)”.

The imidization ratio (value of “(2n+m)/(2l+2m+2n)”) of the polyimide precursor is measured by the following method.

### —Measurement of Imidization Ratio of Polyimide Precursor—

Formation of Polyimide Precursor Sample

(i) A polyimide precursor solution to be measured is applied in a thickness within a range of 1 μm or more and 10 μm or less on a silicone wafer to form a coating film sample.

(ii) The solvent in the coating film sample is substituted by tetrahydrofuran (THF) by immersing the coating film sample in tetrahydrofuran (THF) for 20 minutes. The solvent for immersion is not limited to THF and can be selected from solvents which do not dissolve the polyimide precursor but are miscible with the solvent component contained in the polyimide precursor solution. Usable examples thereof include alcohol solvents such as methanol, ethanol, and the like, and ether compounds such as dioxane and the like.

(iii) The coating film sample is taken out from THF, and THF adhering to the surface of the coating film sample is removed by spraying N₂ gas. Then, the coating film sample is dried by treatment for 12 hours or more under a reduced pressure of 10 mmHg or less within a range of 5° C. or more and 25° C. or less, forming a polyimide precursor sample.

Formation of 100% Imidized Standard Sample

(iv) Similarly to the above (i), the polyimide precursor solution to be measured is applied on a silicone wafer to form a coating film sample.

(v) Imidization reaction is performed by heating the coating film sample at 380° C. for 60 minutes to form a 100% imidized standard sample.

Measurement and Analysis

(vi) An infrared absorption spectrum of each of the 100% imidized standard sample and the polyimide precursor sample is measured by using a Fourier transform infrared spectrophotometer (manufactured by Horiba Ltd. FT-730). In the 100% imidized standard sample, the ratio I′(100) of the absorption peak (Ab′(1780 cm⁻¹)) due to an imide bond near 1780 cm⁻¹ to the absorption peak (Ab′ (1500 cm⁻¹) due to an aromatic ring near 1500 cm⁻¹ is determined.

(vii) Similarly, in measurement of the polyimide precursor sample, the ratio I(x) of the absorption peak (Ab (1780 cm⁻¹)) due to an imide bond near 1780 cm⁻¹ to the absorption peak (Ab (1500 cm⁻¹) due to an aromatic ring near 1500 cm⁻¹ is determined.

By using the measured absorption peaks I′(100) and I(x), the imidization ratio of the polyimide precursor is calculated based on the following formulae.

Imidization ratio of polyimide precursor=I(x)/I′(100) Formula:

I′(100)=(Ab′(1780 cm⁻¹))/(Ab′(1500 cm⁻¹)) Formula:

I(x)=(Ab(1780 cm⁻¹))/(Ab(1500 cm⁻¹)) Formula:

The measurement of the imidization ratio of the polyimide precursor is applied to measurement of the imidization ratio of an aromatic polyimide precursor. In measurement of the imidization ratio of an aliphatic polyimide precursor, a peak due to a structure not changed before and after imidization reaction is used as an internal standard peak in place of the aromatic ring absorption peak.

### [Method for Producing Separator for Lithium Ion Secondary Battery]

A method for producing a separator for a lithium ion secondary battery according to an exemplary embodiment of the present disclosure includes removing the particles from the polyimide film formed by the production method described above.

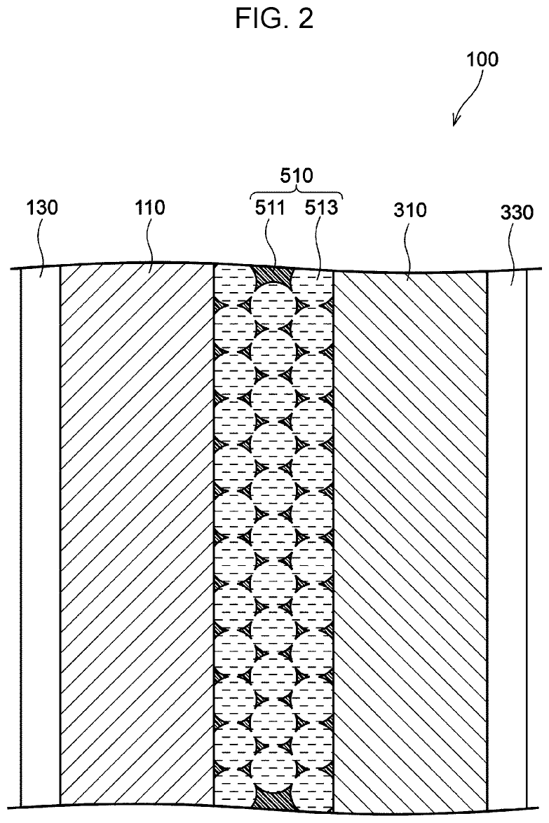

A separator for a lithium ion secondary battery produced by the method for producing a separator for a lithium ion secondary battery according to the exemplary embodiment of the present disclosure contains a porous polyimide film. A lithium ion secondary battery according to an exemplary embodiment of the present disclosure is described below with reference to FIG. 2.

FIG. 2 is a partial schematic sectional view showing an example of a lithium ion secondary battery to which the separator for a lithium ion secondary battery according to the exemplary embodiment of the present disclosure is applied. As shown in FIG. 2, a lithium ion secondary battery 100 includes a positive electrode active material layer 110, a separator layer 510, and a negative electrode active material 310, which are housed in an outer member not shown in the drawing. The positive electrode active material layer 110 is provided on a positive electrode current collector 130, and the negative electrode active material layer 310 is provided on a negative electrode current collector 330. The separator layer 510 is provided so as to separate between the positive electrode active material layer 110 and the negative electrode active material layer 310 and is disposed between the positive electrode active material layer 110 and the negative electrode active material layer 310 so that the positive electrode active material layer 110 and the negative electrode active material layer 310 face each other. The separator layer 510 includes a separator 511 and an electrolytic solution 513 filled in pores of the separator 511. A porous polyimide film obtained by the method for producing the separator for a lithium ion secondary battery according to the exemplary embodiment of the present disclosure is applied to the separator 511. The positive electrode current collector 130 and the negative electrode current collector 330 are members provided according to demand.

### (Positive Electrode Current Collector 130 and Negative Electrode Current Collector 330)

Materials used for the positive electrode current collector 130 and the negative electrode current collector 330 are not particularly limited as long as they are known conductive materials. Usable examples thereof include metals such as aluminum, copper, nickel, titanium, and the like.

### (Positive Electrode Active Material Layer 110)

The positive electrode active material layer 110 is a layer containing a positive electrode active material. If required, the positive electrode active material layer 110 may contain known additives such as a conductive auxiliary agent, a binder resin, etc. The positive electrode active material is not particularly limited, and a known positive electrode active material can be used. Examples thereof include lithium-containing composite oxides (LiCoO₂, LiNiO₂, LiMnO₂, LiMn₂O₄, LiFeMnO₄, LiV₂O₅, and the lie), lithium-containing phosphate salts (LiFePO₄, LiCoPO₄, LiMnPO₄, LiNiPO₄, and the like), conductive polymers (polyacetylene, polyaniline, polypyrrole, polythiophene, and the like), and the like. The positive electrode active materials may be used alone or in combination of two or more.

### (Negative Electrode Active Material Layer 310)

The negative electrode active material layer 310 is a layer containing a negative electrode active material. If required, the negative electrode active material layer 310 may contain known additives such as a binder resin etc. The negative electrode active material is not particularly limited, and a known negative electrode active material can be used. Examples thereof include carbon materials (graphite (natural graphite and artificial graphite), carbon nanotubes, graphitized carbon, low-temperature fired carbon, and the like), metals (aluminum, silicon, zirconium, titanium, and the like), metal oxides (tin dioxide, lithium titanate, and the like), and the like. The negative electrode active materials may be used alone or in combination of two or more.

### (Electrolytic Solution 513)

The electrolytic solution 513 is, for example, a nonaqueous electrolytic solution containing an electrolyte and a nonaqueous solvent.

Examples of the electrolyte include electrolytes of lithium salts (LiPF₆, LiBF₄, LiSbF₆, LiAsF₆, LiClO₄, LiN(FSO₂)₂, LiN(CF₃SO₂)₂, LiN(C₂F₅SO₂), LiC(CF₃SO₂)₃, and the like). The electrolytes may be used alone or in combination of two or more.

Examples of the nonaqueous solvent include cyclic carbonates (ethylene carbonate, propylene carbonate, butylene carbonate, and the like), chain carbonates (diethyl carbonate, dimethyl carbonate, ethylmethyl carbonate, methyl acetate, ethyl acetate, methyl propionate, ethyl propionate, γ-butyrolactone, 1,2-dimethoxyethane, 1,2-diethoxyethane, and the like), and the like. The nonaqueous solvents may be used alone or in combination of two or more.

### (Method for Producing Lithium Ion Secondary Battery 100)

An example of the method for producing the lithium ion secondary battery 100 is described.

First, a coating solution for forming the positive electrode active material layer 110 containing the positive electrode active material is applied and dried on the positive electrode current collector 130 to produce a positive electrode including the positive electrode active material layer 110 provided on the positive electrode current collector 130.

Similarly, a coating solution for forming the negative electrode active material layer 310 containing the negative electrode active material is applied and dried on the negative electrode current collector 330 to produce a negative electrode including the negative electrode active material layer 310 provided on the negative electrode current collector 330. If required, each of the positive electrode and the negative electrode may be compressed.

Next, the separator 511 is disposed between the positive electrode active material layer 110 of the positive electrode and the negative electrode active material layer 310 of the negative electrode so that the positive electrode active material layer 110 of the positive electrode and the negative electrode active material layer 310 of the negative electrode face each other, forming a laminated structure. In the laminated structure, the positive electrode (the positive electrode current collector 130 and the positive electrode active material layer 110), the separator layer 510, and the negative electrode (the negative electrode active material layer 310 and the negative electrode current collector 330) are laminated in that order. If required, the laminated structure may be compressed.

Next, the laminated structure is housed in an outer member, and then the electrolytic solution 513 is injected into the laminated structure. The injected electrolytic solution 513 also permeates into the pores of the separator 511.

Thus, the lithium ion secondary battery 100 is produced.

The lithium ion secondary battery according to the exemplary embodiment of the present disclosure is described above with reference to FIG. 2. However, the lithium ion secondary battery according to the exemplary embodiment of the present disclosure is not limited to this. The form thereof is not particularly limited as long as the porous polyimide film as an example of the polyimide film according to the exemplary embodiment of the present disclosure is applied.

### <All-Solid-State Battery>

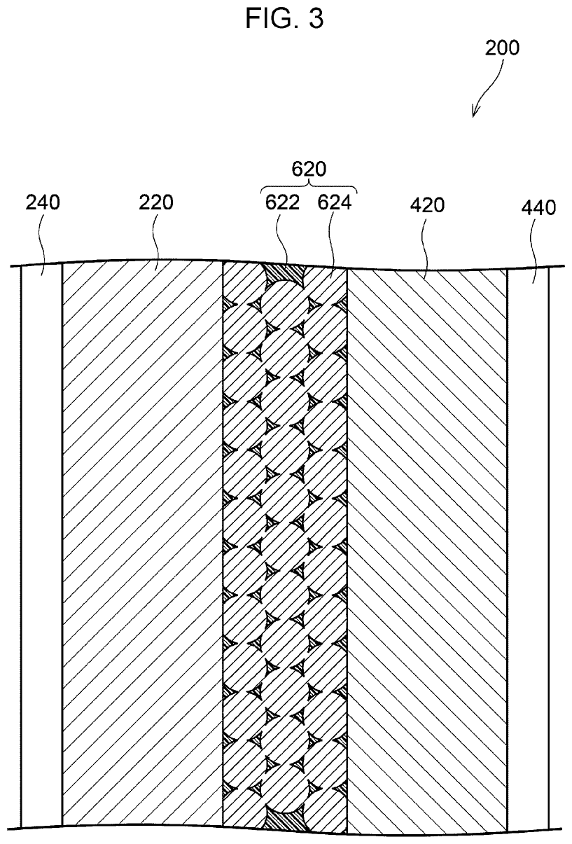

Next, an all-solid-state battery using the polyimide film according to the exemplary embodiment of the present disclosure is described. Description is made blow with reference to FIG. 3.

FIG. 3 is a partial schematic sectional view showing an example of the all-solid-state battery according to the exemplary embodiment of the present disclosure. As shown in FIG. 3, an all-solid-state battery 200 includes a positive electrode active material layer 220, a solid electrolyte layer 620, and a negative electrode active material layer 420, which are housed in an outer member not shown in the drawing. The positive electrode active material layer 220 is provided on a positive electrode current collector 240, and the negative electrode active material layer 420 is provided on a negative electrode current collector 440. The solid electrolyte layer 620 is disposed between the positive electrode active material layer 220 and the negative electrode active material layer 420 so that the positive electrode active material layer 220 and the negative electrode active material layer 420 face each other. The solid electrolyte layer 620 includes a solid electrolyte 624 and a holding body 622 which holds the solid electrolyte 624, and the pores of the holding body 622 are filled with the solid electrolyte 624. The polyimide film according to the exemplary embodiment of the present disclosure is applied to the holding body 622 which holds the solid electrolyte 624. The positive electrode current collector 240 and the negative electrode current collector 440 are members provided according to demand.

### (Positive Electrode Current Collector 240 and Negative Electrode Current Collector 440)

Examples of the materials used for the positive electrode current collector 240 and the negative electrode current collector 440 include the same materials as those described above for the lithium ion secondary battery.

### (Positive Electrode Active Material Layer 220 and Negative Electrode Active Material Layer 420)

Examples of the materials used for the positive electrode active material layer 220 and the negative electrode active material layer 420 include the same materials as those described above for the lithium ion secondary battery.

### (Solid Electrolyte 624)

The solid electrolyte 624 is not particularly limited, and a known solid electrolyte can be used. Examples thereof include a polymer solid electrolyte, an oxide solid electrolyte, a sulfide solid electrolyte, a halide solid electrolyte, a nitride solid electrolyte, and the like.

Examples of the polymer solid electrolyte include fluorocarbon resins (homopolymers such as polyvinylidene fluoride, polyhexafluoropropylene, polytetrafluoroethylene, and the like, copolymers each having these as constituent units, and the like), polyethylene oxide resins, polyacrylonitrile resins, polyacrylate resins, and the like. The sulfide solid electrolyte is preferably contained in view of excellent lithium ion conductivity. In view of the same, the sulfide solid electrolyte containing, as a constituent element, at least one of sulfur, lithium, and phosphorus is preferably used.

The oxide solid electrolyte is, for example, particles of a lithium-containing oxide solid electrolyte. Examples thereof include Li₂O—B₂O₃—P₂O₅, Li₂O—SiO₂, and the like.

The sulfide solid electrolyte is, for example, a sulfide solid electrolyte containing, as a constituent element, at least one of sulfur, lithium, and phosphorus. Examples thereof include 8Li₂O.67Li₂S.25P₂S₅, Li₂S, P₂S₅, Li₂S—SiS₂, LiI—Li₂S—SiS₂, LiI—Li₂S—P₂S₅, LiI—Li₃PO₄—P₂S₅, LiI—Li₂S—P₂O₅, LiI—Li₂S—B₂S₃, and the like.

Examples of the halide solid electrolyte include LiI and the like.

Examples of the nitride solid electrolyte include Li₃N and the like.

(Method for Producing all-Solid-State Battery 200)

An example of a method for producing the all-solid-state battery 200 is described.

A coating solution for forming the positive electrode active material layer 220 containing a positive electrode active material is applied and dried on the positive electrode current collector 240 to produce a positive electrode including the positive electrode active material layer 220 provided on the positive electrode current collector 240.

Similarly, a coating solution for forming the negative electrode active material layer 420 containing a negative electrode active material is applied and dried on the negative electrode current collector 440 to produce a negative electrode including the negative electrode active material layer 420 provided on the negative electrode current collector 440.

If required, each of the positive electrode and the negative electrode may be compressed.

Next, a coating solution for forming the solid electrolyte layer 620, which contains the solid electrolyte 624, is applied and dried on a substrate to form a layered solid electrolyte.

Next, a porous polyimide film serving as the holding body 622 and the layered solid electrolyte 624 are superposed as a material for forming the solid electrolyte layer 620 on the positive electrode active material layer 220 of the positive electrode. Further, the negative electrode is superposed on the material for forming the solid electrolyte layer 620 so that the negative electrode active material layer 420 of the negative electrode faces the positive electrode active material layer 220 side, forming a laminated structure. In the laminated structure, the positive electrode (the positive electrode current collector 240 and the positive electrode active material layer 220), the solid electrolyte layer 620, and the negative electrode (the negative electrode active material layer 420 and the negative electrode current collector 440) are laminated in that order.

Next, by compressing the laminated structure, the solid electrolyte 624 is impregnated into the pores of the porous polyimide film serving as the holding body 622, and the solid electrolyte 624 is held.

Next, the laminated structure is housed in an outer member.

Thus, the all-solid-state battery 200 is produced.

The all-solid-state battery according to the exemplary embodiment of the present disclosure is described above with reference to FIG. 3, but the all-soli-state battery is not limited to this. The form is not particularly limited as long as the porous polyimide film according to the exemplary embodiment of the present disclosure is applied.

### EXAMPLES

Examples are described below, but the present disclosure is not limited to these examples. In addition, in description below, “parts” and “%” are on mass basis unless otherwise specified.

### <Production of Particles>

### —Resin Particles (1-1)—

First, 300 parts by mass of styrene, 11.9 parts by mass of surfactant DOWFAX 2A1 (47% solution, manufactured by Dow Chemical Company), and 150 parts by mass of deionized water are mixed and then stirred and emulsified by a dissolver at 1,500 revolutions for 30 minutes, forming a monomer emulsion. Then, 0.9 parts by mass of DOWFAX 2A1 (47% solution, manufactured by Dow Chemical Company) and 446.8 parts by mass of deionized water are added to a reactor. The resultant mixture is heated to 75° C. in a nitrogen stream, and then 24 parts by mass of the monomer emulsion is added to the mixture. Then, a polymerization initiator solution prepared by dissolving 5.4 parts by mass of ammonium persulfate in 25 parts by mass of deionized water is added dropwise over 10 minutes. After reaction for 50 minutes after dropwise addition, the remaining monomer emulsion is added dropwise over 180 minutes and further reacted for 180 minutes. Then, the reaction solution is cooled to produce a resin particle dispersion (1-1). The solid content concentration of the resin particle dispersion (1-1) is 36.0% by mass. Also, the resultant resin particles have an average particle diameter of 0.38 μm.

### —Resin Particles (1-2)—

A resin particle dispersion (1-2) is prepared by the same method as for the resin particle dispersion (1-1) except that styrene is replaced by methyl methacrylate. The solid content concentration of the resin particle dispersion (1-2) is 36.0% by mass. Also, the resultant resin particles have an average particle diameter of 0.37 μm.

### Example 1

### (Preparation of Polyimide Precursor Solution)

### —Polyimide Precursor Dispersion (2-1)—

First, 31.05 g of 3,3′,4,4′biphenyltetracarboxylic dianhydride (also referred to as “BPDA” hereinafter) and 11.41 g of p-phenylenediamine (also referred to as “PDA” hereinafter) are added, and water and the resin particle dispersion (1-1) are added at a ratio shown in Table 1, heated to 50° C., and then stirred. Then, a mixture of NMP, N-methylmorpholine (also referred to as “MMO” hereinafter), and water is added dropwise over the time shown in Table 1, dissolved by stirring for 24 hours, and then reacted to prepare a polyimide precursor dispersion (2-1). The results are shown in Table 1.

### Examples 2 to 8 and Comparative Examples 1 to 7

Polyimide precursor dispersions (2-2) to (2-8) and polyimide precursor dispersions (3-1) to (3-7) are prepared by the same method as in Example 1 except that as shown in Table 1, the water-soluble organic solvent (B), the organic amine compound (A), and water (C) are added, and the dropping time of each of the resultant mixtures is adjusted. The results are shown in Table 1.

### <Evaluation>

A film is formed by using the polyimide precursor solution obtained in each of the examples, and the film forming properties of the film are evaluated.

### (Film Forming Method)

The polyimide precursor solution is applied by a bar coating method using a coating blade provided with a spacer so that the coating thickness is 500 μm.
Coating substrate: 1.1 mm t glass plate
Drying temperature: 60° C.×10 minutes
Firing temperature: 250° C.×30 minutes

### (Film Forming Properties)

The thickness unevenness of each of the formed films is evaluated.

The thickness unevenness of each of the formed films is evaluated as follows. A sample of 1 cm×10 cm is obtained from the resultant coating film, and the thickness is measured at seven points in the longitudinal direction of the sample and an average value is calculated. In addition, the evaluation criteria are as follows. The results are shown in Table 1.

A: Both the ratio of average value to maximum value and the ratio of average value to minimum value are 0.9 or more and less than 1.1.

B: Either the ratio of average value to maximum value or the ratio of average value to minimum value is 0.8 or more and less than 0.9 or 1.1 or more and less than 1.2.

C: Either the ratio of average value to maximum value or the ratio of average value to minimum value is less than 0.8 or 1.2 or more.

TABLE 1

| | | | | | | Dropping | | Volume | | |
|---|---|---|---|---|---|---|---|---|---|---|
| | | Polyimide | Type of water- | Type of | Mw of | time of | Particle | ratio of | | Evaluation |
| | | precursor | soluble organic | organic amine | polyimide | mixture | dispersion | particles | Content ratio | of thickness |
| | | dispersion No. | solvent (B) | compound (A) | precursor | (min) | No. | (%) | A:B:C | unevenness |
| Example | 1 | (2-1) | NMP | MMO | 50000 | 60 | (1-1)PSt | 60 | 0.05:0.03:0.92 | A |
| | 2 | (2-2) | NMP | MMO | 21000 | 30 | (1-1)PSt | 60 | 0.07:0.02:0.91 | B |
| | 3 | (2-3) | NMP | MMO | 78000 | 90 | (1-1)PSt | 60 | 0.02:0.05:0.93 | B |
| | 4 | (2-4) | NMP | MMO | 51000 | 60 | (1-2)PMMA | 60 | 0.02:0.02:0.96 | A |
| | 5 | (2-5) | NMP | Triethylamine | 49000 | 60 | (1-1)PSt | 60 | 0.07:0.05:0.88 | B |
| | 6 | (2-6) | 1,3-Dimethyl-2- | N-Alkyl- | 21000 | 30 | (1-1)PSt | 80 | 0.05:0.03:0.92 | A |
| | | | imidazolidinone | piperidine | | | | | | |
| | 7 | (2-7) | N,N-Dimethyl- | 2-Dimethyl- | 21200 | 30 | (1-1)PSt | 40 | 0.05:0.03:0.92 | A |
| | | | formamide | amino ethanol | | | | | | |
| | 8 | (2-8) | N,N-Dimethyl- | MMO | 21000 | 30 | (1-1)PSt | 60 | 0.05:0.03:0.92 | A |
| | | | acetamide | | | | | | | |
| Comparative | 1 | (3-1) | NMP | MMO | 50500 | 60 | (1-1)PSt | 60 | 0.08:0.03:0.89 | C |
| Example | 2 | (3-2) | NMP | MMO | 50600 | 60 | (1-1)PSt | 60 | 0.01:0.03:0.96 | C |
| | 3 | (3-3) | NMP | MMO | 50300 | 60 | (1-1)PSt | 60 | 0.05:0.06:0.89 | C |
| | 4 | (3-4) | NMP | MMO | 51000 | 60 | (1-1)PSt | 60 | 0.06:0.01:0.93 | C |
| | 5 | (3-5) | NMP | MMO | 50900 | 60 | (1-1)PSt | 60 | 0.01:0.02:0.97 | C |
| | 6 | (3-6) | NMP | MMO | 51100 | 60 | (1-1)PSt | 60 | 0.07:0.06:0.87 | C |
| | 7 | (3-7) | No | MMO | 51400 | 60 | (1-1)PSt | 60 | — | C |

The results shown in Table 1 indicate that the thickness unevenness of the polyimide films formed in the examples is suppressed as compared with those formed in the comparative examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A polyimide precursor solution comprising:
a polyimide precursor having a weight average molecular weight within a range of 20,000 to 80,000;
particles; and
an aqueous solvent,
wherein the aqueous solvent contains an organic amine compound (A) (excluding a water-soluble organic solvent (B) described below), a water-soluble organic solvent (B) containing at least one selected from the group consisting of N-methyl-2-pyrrolidone, 1,3-dimethyl-2-imidazolidinone, N,N-dimethylformamide, and N,N-dimethylacetamide, and water (C); and
a content ratio [(A):(B):(C)] of (A), (B), and (C) is within a range of 0.02 to 0.07:0.02 to 0.05:0.88 to 0.96 in terms of mass ratio.

2. The polyimide precursor solution according to claim 1, wherein the organic amine compound is selected from the group consisting of triethylamine, N-alkylpiperidine, 2-dimethylaminoethanol, and a tertiary cyclic amine compound.

3. The polyimide precursor solution according to claim 2, wherein the tertiary cyclic amine compound is a morpholine compound.

4. The polyimide precursor solution according to claim 3, wherein the morpholine compound is N-methylmorpholine.

5. The polyimide precursor solution according to claim 1, wherein the particles are contained within a range of 40% by volume to 85%, by volume relative to a total volume of a solid content of the polyimide precursor and the particles.

6. The polyimide precursor solution according to claim 5, wherein a content of the particles is within a range of 50% by volume to 80% by volume.

7. The polyimide precursor solution according to claim 1, wherein the weight average molecular weight of the polyimide precursor is within a range of 30000 to 80000.

8. The polyimide precursor solution according to claim 1, wherein the particles are resin particles.

9. The polyimide precursor solution according to claim 8, wherein the resin particles are selected from styrene resin particles, (meth)acrylic resin particles, and polyester resin particles.

10. The polyimide precursor solution according to claim 1, wherein a content ratio of the water (C) relative to the polyimide precursor is within a range of 900% by mass to 5000% by mass.

11. The polyimide precursor solution according to claim 1, wherein the content ratio [(A):(B):(C)] is within a range of 0.02 to 0.03:0.03 to 0.05:0.92 to 0.96 in terms of mass ratio.

12. A method for producing a polyimide resin film, comprising:
applying the polyimide precursor solution according to claim 1 on a substrate to form a coating film; and
drying the coating film to form a film containing the polyimide precursor and the particles.

13. The method for producing a polyimide resin film according to claim 12, comprising:
imidizing the polyimide precursor contained in the film by heating the dried film to form a polyimide film; and
removing the particles.
